(19) United States
(12) Patent Application Publication
(10) Pub. No.: US 2019/0010352 A1
(43) Pub. Date: Jan. 10, 2019

(54) METHODS FOR COATING INNER SURFACES OF PIPES AND COATD PIPES FORMED THEREBY

(71) Applicant: 3M INNOVATIVE PROPERTIES COMPANY, St Paul, MN (US)

(72) Inventors: Martin A. Hutchinson, North Yorkshire (GB); Ian Robinson, North Yorkshire (GB)

(21) Appl. No.: 16/066,246

(22) PCT Filed: Dec. 15, 2016
(86) PCT No.: PCT/US2016/066864

§ 371 Date: Jun. 26, 2018

Related U.S. Application Data
(60) Provisional application No. 62/271,583, filed on Dec. 28, 2015.

(51) Int. Cl. C09D 163/00; C09D 5/08; C08G 59/24; C08G 59/44; B05D 1/02; B05D 7/22

(52) U.S. Cl. CPC C09D 163/00; C09D 5/08; B05D 7/222; C08G 59/44; B05D 1/02; C08G 59/245

(57) ABSTRACT

Methods of coating an inner surface of a pipe and the pipes coated thereby; the methods including mixing a first composition with a second composition to form a coating composition, the first composition including epoxy resin and diluent; and the second composition including a curing agent, the curing agent including a phenalkamide curing agent; and applying the coating composition to the inner surface of the pipe.

### FIELD

The present disclosure relates to methods of coating inner surfaces of pipes and pipes formed thereby.

### SUMMARY

Disclosed herein are methods of coating an inner surface of a pipe, the methods including mixing a first composition with a second composition to form a coating composition, the first composition including epoxy resin and diluent; and the second composition including a curing agent, the curing agent including a phenalkamide curing agent; and applying the coating composition to the inner surface of the pipe.

Also disclosed herein are coated pipes that include a pipe having an inner surface and an outer surface; and a coating in contact with at least a portion of the inner surface of the pipe, the coating the reaction product of: a first composition including epoxy resin and a diluent; and a second composition including a curing agent, the curing agent including a phenalkamide curing agent.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DETAILED DESCRIPTION

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise. The term “and/or” means one or all of the listed elements or a combination of any two or more of the listed elements.

As used herein, “have”, “having”, “include”, “including”, “comprise”, “comprising” or the like are used in their open ended sense, and generally mean “including, but not limited to”. It will be understood that “consisting essentially of”, “consisting of”, and the like are subsumed in “comprising” and the like. For example, a conductive trace that “comprises” silver may be a conductive trace that “consists of” silver or that “consists essentially of” silver.

As used herein, “consisting essentially of,” as it relates to a composition, apparatus, system, method or the like, means that the components of the composition, apparatus, system, method or the like are limited to the enumerated components and any other components that do not materially affect the basic and novel characteristic(s) of the composition, apparatus, system, method or the like.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

Also herein, the recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” a particular value, that value is included within the range. All upper and lower limits can be combined in any combination to form ranges for the particular component or property for example.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

Use of “first,” “second,” etc. in the description above and the claims that follow is not intended to necessarily indicate that the enumerated number of steps are present. For example, a “second” step is merely intended to differentiate from another step (such as a “first” step). Use of “first,” “second,” etc. in the description above and the claims that follow is also not necessarily intended to indicate that one comes earlier in time than the other.

When a group is present more than once in a formula described herein, each group is “independently” selected, whether specifically stated or not. For example, when more than one R¹ group is present in a formula, each R¹ group is independently selected. Furthermore, subgroups contained within these groups are also independently selected.

As used herein, the term “room temperature” refers to a temperature of about 20° C. to about 25° C. or about 22° C. to about 25° C.

Numerous fluids are transported from one location to another via piping. A specific example of such fluids is natural gas, which is often transported great distances via pipelines. Internal coating of natural gas pipelines is utilized in order to reduce friction and improve flow efficiency when conveying natural gas in pipelines. Internal coatings with reduced surface roughness reduce the friction factor of the pipe wall.

Two component epoxy coatings are commonly utilized as internal flow efficiency coatings for natural gas transmission pipelines. The coating compositions typically have a solvent contents of 40% to 50% by weight and are based on solid or semi-solid epoxy resins cured with polyamide or amine adduct curing agents. These typically utilized 50% solvent coatings cannot provide the desired low levels of surface roughness. 100% solids coatings are available but are not amenable to pipeline coating because of high material costs and more complex application processes. Intermediate (25% to 40%) solvent content products are available but are also at a cost that make them undesirable. Therefore, there remains a need for a minimum solvent content product which utilizes common liquid epoxy resins, maintains a minimum cost and can be applied using standard airless spray or duel feed airless spray equipment using minimal heating requirements.

Disclosed herein are methods of coating inner surfaces of pipes and pipes coated thereby. The methods include steps of mixing a first composition and a second composition, or vice versa to form a coating composition and applying the coating composition to an inner surface of a pipe. Also included are pipes that have an inner surface and a coating in contact with the inner surface, the coating comprising the reaction product of a first composition and a second composition. First and second are utilized herein to refer to the compositions in order to distinguish the two compositions, nothing is implied regarding order of addition or mixing. First compositions utilized herein can include at least a liquid epoxy resin and a diluent. Epoxy resins, also known as polyepoxides, refer to a class of reactive prepolymers, polymers, or combinations thereof that contain epoxide groups (an oxygen atom attached to two adjacent carbon atoms). Illustrative epoxy resins can include, for example bisphenol A epoxy resins, bisphenol F epoxy resins, novolac epoxy resins, aliphatic epoxy resins and glycidylamine epoxy resins. In some embodiments, bisphenol A epoxy resins, bisphenol F epoxy resins, or combinations thereof may be utilized. In some embodiments, one or more bisphenol A epoxy resin can be utilized. In some embodiments, specific bisphenol A resins that may be utilized can include bisphenol A diglycidyl ether (BADGE) resins. In some embodiments, epoxy resins utilized herein can be liquid at room temperature conditions, such epoxy resins can be referred to as liquid epoxy resins.

First compositions utilized herein also include a diluent. The diluent can be characterized as a reactive diluent in that it becomes part of the cured material once the two compositions are mixed together and reacted. The diluent can include an epoxy functionality. The diluent can also include one or more functionalities or portions that are similar to or compatible with at least some portion of at least some of the curing agent (in a case where more than one type of curing agent is utilized). The diluent may function as a compatabilizer for the epoxy resin and the curing agent (in the second composition).

In some embodiments, the diluent can be characterized by the epoxy equivalent weight (weight in grams of resin containing 1 mole equivalent of epoxide (g/1 mol)) thereof. For example, in some embodiments, illustrative diluents can have an epoxy equivalent weight of not less than 200 g/1 mol, or not less than 300 g/1 mol. In some embodiments, illustrative diluents can have an epoxy equivalent weigh of not greater than 600 g/1 mol, or not greater than 400 g/1 mol. In some embodiments, the diluent can be characterized by the viscosity thereof. In some embodiments a diluent can have a dynamic viscosity of not greater than 70 cp at 20° C., not greater than 40 cp at 20° C., or not greater than 25 cp at 20° C., for example. The first composition can be described by the amount of epoxy resin or amount of diluent in the first composition. In some embodiments, the first composition can contain not less than 30 percent (wt %) epoxy resin based on the total weight of the first composition, not less than 35 wt % epoxy resin based on the total weight of the first composition, or not less than 40 wt % epoxy resin based on the total weight of the first composition, for example. In some embodiments, the first composition can contain not greater than 60 wt % epoxy resin based on the total weight of the first composition, not greater than 55 wt % epoxy resin based on the total weight of the first composition, or not greater than 50 wt % epoxy resin based on the total weight of the first composition, for example. In some embodiments, the first composition can contain not less than 4 wt % diluent based on the total weight of the first composition, not less than 6 wt % diluent based on the total weight of the first composition, or not less than 8 wt % diluent based on the total weight of the first composition, for example. In some embodiments, the first composition can contain not greater than 14 wt % diluent based on the total weight of the first composition, not greater than 12 wt % diluent based on the total weight of the first composition, or not greater than 10 wt % diluent based on the total weight of the first composition, for example.

The first composition can also optionally include one or more solvents. Any commonly utilized organic solvents can be utilized in the first composition. The particular solvent or solvents utilized can depend at least in part on the particular epoxy resin, diluent, other components of the first composition, components of the second composition, or any combination thereof. Other considerations that may play a role in choosing a solvent(s) can include evaporation rate, toxicity, cost, flash point or combinations thereof. Illustrative classes of solvents can include aromatic hydrocarbons such as xylene and toluene for example; acetates such as methyl acetate, ethyl acetate, propyl acetate, butyl acetate, propyl acetate and hexyl acetate, for example; alcohols such as butanol or isopropanol, for example; glycol ethers such propylene glycol methyl ether, ethylene glycol methyl ether and dipropylene glycol methyl ether; and other solvents suitable for two pack epoxies which may be known to those familiar in the art. In some embodiments, xylene, butyl acetate, or combinations thereof may be utilized as they may have advantageous rates of evaporation.

The first composition can also include other optional components. Illustrative optional components that can be included in the first composition can include, for example, dispersants, suspension agents, leveling agents, defoaming agents (e.g., deaearating agents), wetting agents, surfactants, emulsifiers, thixotropic agents, viscosity/flow modifiers, fillers, pigments, and combinations thereof. The particular identities of such optional agents, the amounts of such agents, and any other relevant details would be known to one of skill in the art.

Disclosed methods also include use of a second composition. Second compositions utilized herein can include a curing agent. The particular curing agent can depend, at least in part on the particular epoxy resin included in the first composition. The curing agent can also be chosen, at least based in part, based on effects it may have on other components of the second composition, the first composition, or both; the speed of curing it effects; one or more properties of the cured composition; the cost of the curing agent(s); the toxicity of the curing agent(s); or any combination thereof, for example. In some embodiments, more than one curing agent can be utilized. For example, two curing agents could be utilized because they both provide one or more different properties to the final composition, the process of obtaining the final composition (e.g., curing, mixing, coating, etc.), or combinations thereof.

In some embodiments, the second composition can include a phenalkamide curing agent. Phenalkamide curing agents may provide properties and benefits between or a combination of those provided by polyamide and phenalkamine curing agents. Phenalkamide curing agents may provide low temperature curing, relatively fast curing, excellent anti-corrosion properties, or combinations thereof. Phenalkamide curing agents may be highly advantageous because of their relatively low cost, relatively high performance, or both. However, phenalkamide curing agents are not highly compatible with some epoxy resins. Phenalkamide curing agents are commercially available from Cardolite Corporation, Newark, N.J. under the tradename LITE (e.g., LITE 3040, LITE 3060 and NX-5052).

If the epoxy resin and the curing agent are not compatible, the coating formed thereby may be undesirably hazy and have an absence of sheen unless sufficient time is provided after mixing the two and before coating the composition. In situations where the two compositions are mixed and applied via spray coating or more specifically airless spray coating, e.g., in commonly utilized methods of coating pipes, a delay between mixing and coating is highly disadvantageous and could require different processes to be utilized. For this reason, disclosed methods include the diluent as a compatabilizer. Therefore, disclosed methods and coated pipes offer the heretofore unattainable competing advantages of low cost, fast curing and desirable properties provided by the phenalkamide curing agents in a composition that can be applied via an airless or dual feed sprayer without the need for a delay between mixing and application. As an added advantage, heating of the two compositions, coating composition, or both is also not necessary.

The second composition can be described by the amount of phenalkamide curing agent in the second composition. In some embodiments, the second composition can contain not less than 60 percent (wt %) phenalkamide curing agent based on the total weight of the second composition, not less than 70 wt % phenalkamide curing agent based on the total weight of the second composition, or not less than 45 wt % phenalkamide curing agent based on the total weight of the second composition, for example. In some embodiments, the second composition can contain nothing but the phenalkamide curing agent. In some embodiments where the second composition includes something other than the phenalkamide curing agent, the second composition can contain not greater than 90 wt % phenalkamide curing agent based on the total weight of the second composition, not greater than 85 wt % phenalkamide curing agent based on the total weight of the second composition or not greater than 80 wt % phenalkamide curing agent based on the total weight of the second composition.

A second composition may also optionally include a second curing agent. A second curing agent may be utilized to provide some other property to a final composition or coating, some other advantage to the process (e.g., curing, mixing, coating, etc.), or any combination thereof. In some embodiments, a second optional curing agent can be utilized because it provides advantageous properties to the rate of curing, for example it could increase the rate of curing. In some embodiments, a second optional curing agent can be utilized because it provides advantageous properties to the final coating, for example it could increase the hardness of the final coating. In some embodiments, a second optional curing agent can be utilized because it both provides an increased rate of curing and an increased hardness of the final coating. Illustrative optional second curing agents can include, for example phenalkamine curing agents. Phenalkamine curing agents may be advantageous because they can provide relatively fast curing, relatively low temperature curing, good chemical resistance to the final coating, good surface appearance to the final coating, good moisture tolerance to the final coating, and non-blushing properties, for example. Phenalkamine curing agents are commercially available from the Cardolite Corporation, Newark, N.J. under various tradenames (e.g., NC-541, NC-641, NC-541X90, LITE 2001, LITE 2001X90, NC-562, LITE 2562, NX-2018, NX-5459 and Ultra LITE 2009).

The second composition can also optionally include one or more solvents. Any commonly utilized organic solvents can be utilized in the second composition. The particular solvent or solvents utilized can depend at least in part on the particular phenalkamide curing agent, other optional curing agent, epoxy resin, diluent, other components of the first composition, other components of the second composition, or any combination thereof. Other considerations that may play a role in choosing a solvent(s) can include evaporation rate, toxicity, cost, flash point or combinations thereof. Illustrative classes of solvents can include aromatic hydrocarbons such as xylene and toluene for example; acetates such as methyl acetate, ethyl acetate, propyl acetate, butyl acetate, propyl acetate and hexyl acetate, for example; alcohols such as butanol or isopropanol, for example; glycol ethers such propylene glycol methyl ether, ethylene glycol methyl ether and dipropylene glycol methyl ether; and other solvents suitable for two pack epoxies which may be known to those familiar in the art. In some embodiments, xylene, butyl acetate, or combinations thereof may be utilized as they may have advantageous rates of evaporation.

The second composition can also include other optional components. Illustrative optional components that can be included in the second composition can include, for example, dispersants, suspension agents, leveling agents, defoaming agents (e.g., deaearating agents), wetting agents, surfactants, emulsifiers, thixotropic agents, viscosity/flow modifiers, fillers, pigments, and combinations thereof. The particular identities of such optional agents, the amounts of such agents, and any other relevant details would be known to one of skill in the art.

The first composition, the second composition, both the first and second composition, or neither the first or second composition may contain one or more solvents. Stated another way, the coating composition (the combination of the two compositions) may be solvent free or may contain solvent. In some embodiments, only the first composition includes solvent. In some embodiments, only the second composition includes solvent. In some composition both the first composition and the second composition include solvents. In some compositions, neither the first composition nor the second composition include solvents.

The first composition and the second composition are mixed to form a coating composition. In some embodiments, the two compositions can be housed separately and then mixed via a static mixer before being taken up in a spraying apparatus; or the two compositions can be mixed together manually and fed into spraying equipment. In some embodiments, mixing the two compositions can occur at room temperature, below room temperature, or above room temperature.

The amounts of the epoxy resin, diluent, curing agent (total amount, including the phenalkamide curing agent and any optional second curing agent) and solvent can be described with respect to the amounts thereof in a final coating composition. In some embodiments, a coating composition can include not less than 50 percent by weight (wt %) total epoxy resin based on the total weight of epoxy resin, diluent, curing agent and solvent, not less than 55 wt % total epoxy resin based on the total weight of epoxy resin, diluent, curing agent and solvent, or not less than 57 wt % total epoxy resin based on the total weight of epoxy resin, diluent, curing agent and solvent. In some embodiments, a coating composition can include not greater than 65 wt % total epoxy resin based on the total weight of epoxy resin, diluent, curing agent and solvent, not greater than 60 wt % total epoxy resin based on the total weight of epoxy resin, diluent, curing agent and solvent, or not greater than 59 wt % total epoxy resin based on the total weight of epoxy resin, diluent, curing agent and solvent.

In some embodiments, a coating composition can include not less than 5 wt % total diluent based on the total weight of epoxy resin, diluent, curing agent and solvent, not less than 8 wt % total diluent based on the total weight of epoxy resin, diluent, curing agent and solvent, or not less than 10 wt % total diluent based on the total weight of epoxy resin, diluent, curing agent and solvent. In some embodiments, a coating composition can include not greater than 25 wt % total diluent based on the total weight of epoxy resin, diluent, curing agent and solvent, not greater than 20 wt % total diluent based on the total weight of epoxy resin, diluent, curing agent and solvent, or not greater than 15 wt % total diluent based on the total weight of epoxy resin, diluent, curing agent and solvent.

In some embodiments, a coating composition can include not less than 20 wt % total curing agent based on the total weight of epoxy resin, diluent, curing agent and solvent, not less than 25 wt % total curing agent based on the total weight of epoxy resin, diluent, curing agent and solvent, or not less than 27 wt % total curing agent based on the total weight of epoxy resin, diluent, curing agent and solvent. In some embodiments, a coating composition can include not greater than 40 wt % total curing agent based on the total weight of epoxy resin, diluent, curing agent and solvent, not greater than 35 wt % total curing agent based on the total weight of epoxy resin, diluent, curing agent and solvent, or not greater than 31 wt % total curing agent based on the total weight of epoxy resin, diluent, curing agent and solvent.

In some embodiments, a coating composition can include not greater than 30 wt % total solvent based on the total weight of epoxy resin, diluent, curing agent and solvent, not greater than 25 wt % total solvent based on the total weight of epoxy resin, diluent, curing agent and solvent, or not greater than 18 wt % total solvent based on the total weight of epoxy resin, diluent, curing agent and solvent.

The coating composition can also be described by its dynamic viscosity. The coating composition can generally be described as being appropriately viscous for the particular application method chosen. In some embodiments, the coating composition can have a dynamic viscosity not less than 1 poise at 20° C., not less than 2 poise at 20° C., or not less than 3 poise at 20° C., for example. In some embodiments, the coating composition can have a dynamic viscosity not greater than 8 poise at 20° C., not greater than 6 poise at 20° C., or not greater than 5 poise at 20° C., for example.

In some embodiments a first composition can include a bisphenol A diglycidyl ether epoxy resin and an epoxy functional cashew nutshell liquid (CNSL) based diluent and the second composition can include a phenalkamide curing agent based on CNSL. In some embodiments a first composition can include a bisphenol A diglycidyl ether epoxy resin and an epoxy functional cashew nutshell liquid (CNSL) based diluent and the second composition can include a phenalkamide curing agent based on CNSL and a polyamine curing agent. In some embodiments a first composition can include a bisphenol A diglycidyl ether epoxy resin, an epoxy functional cashew nutshell liquid (CNSL) based diluent, and at least one solvent and the second composition can include a phenalkamide curing agent based on CNSL, a polyamine curing agent and at least one solvent.

Disclosed methods can include use of various equipment, including for example airless sprayers where a liquid is placed under high pressure (e.g., about 3000 pounds per square inch (PSI) or greater). The airless sprayers can be standard airless sprayers or dual feed airless sprayers, for example. Equipment and processes such as that provided in the American Petroleum Institute (API) Recommended Practices (RP) for Internal Coating of Line Pipe for Non-Corrosive Gas Transmission Service (API RP 5L2, 4^{th} Ed. July 2002) can incorporate or utilize disclosed methods and compositions. Alternatively or additionally, larger processes, such as the manufacturing of piping or pipe can combine disclosed methods to produce interior coated piping or pipe. Any processes, techniques, or combinations thereof typically utilized in methods or processes such as that illustrated by API RP 5L2 can be utilized in disclosed methods.

A pipe can generally be described as having an inner surface and an opposing outer surface. Methods and coatings discussed herein are typically for application to some portion of the inner surface of a pipe. Once the two compositions are mixed to form a coating composition, the coating composition can then be applied to an inner surface of a pipe.

Also disclosed herein are pipes having an inner surface and an opposing outer surface and a coating in contact with at least some portion of the inner surface of the pipe. The coating is a reaction product of at least the first composition and the second composition discussed above. The reaction product can also be referred to as the cured product formed via mixing at least the first and second compositions discussed above. The coating can therefore be described as a cured epoxy based polymer.

The coating on the inner surface of the pipe can have various thicknesses. In some embodiments, the coating can have a thickness of not less than 40 micrometers, not less than 50 micrometers, or not less than 70 micrometers, for example. In some embodiments, the coating can have a thickness of not greater than 150 micrometers, not greater than 120 micrometers, or not greater than 90 micrometers, for example.

The coating can be characterized by various properties, including for example gloss, hardness, flexibility, solvent resistance, effect of salt spray, effect of immersion in various material (e.g. a CaCO₃ solution in water or a mixture of water and methanol), ability to withstand stripping by mechanical means, ability to withstand bending, adhesion, abrasion, ability to withstand blistering under hydraulic pressure, ability to withstand pressure variations in gas, and resistance to various chemicals (e.g., diethyleneglycol (DEG), triethyleneglycol (TEG), methanol, hexane, toluene, cyclohexane, lubricating oil, mono ethyleneglycol (MEG), and methyldiethanolamine (MDEA)). Any of these properties (or combinations thereof) may be relevant when determining if a particular coating or a pipe coated with a particular coating may provide desirable or acceptable properties.

In some embodiments, an advantageous coating is one that has a gloss rating of not less than 50 as measured by BS EN ISO 2813 at 60°, not less than 75 as measured by BS EN ISO 2813 at 60°, not less than 80 as measured by BS EN ISO 2813 at 60°, or not less than 85 as measured by BS EN ISO 2813 at 60°. In some embodiments, an advantageous coating is one that has an average hardness of not less than 94 Buchholz at room temperature (e.g. about 25° C. or 25±1° C.) when measured using ISO 2815. In some embodiments, an advantageous coating is one that has a flexibility, as measured by the Bend test of ISO 6860 of not greater than 13 mm, not greater than 10 mm, or not greater than 7 mm. In some embodiments, an advantageous coating is one that has resistance to solvent of not less than 20 double rubs, not less than 30 double rubs, or not less than 40 double rubs as measured by ASTM D5402-06 using methyl ethyl ketone as the solvent.

The following is a summary of particular, specific embodiments of the present disclosure. Some illustrative embodiments include methods of coating an inner surface of a pipe, the method comprising: mixing a first composition with a second composition to form a coating composition, the first composition comprising epoxy resin and diluent; and the second composition comprising a curing agent, the curing agent comprising a phenalkamide curing agent; and applying the coating composition to the inner surface of the pipe.

In the following paragraph “such methods” refer to the illustrative method immediately above as well as any other methods disclosed in this paragraph or application generally. Such methods, wherein the first composition, the second composition, or both further comprise solvent. Such methods, wherein the coating composition comprises not greater than about 30 wt % solvent based on the total weight of the epoxy resin, diluent, curing agent and solvent. Such methods, wherein the coating composition comprises not greater than about 25 wt % solvent based on the total weight of the epoxy resin, diluent, curing agent and solvent. Such methods, wherein the coating composition comprises not greater than about 18 wt % solvent based on the total weight of the epoxy resin, diluent, curing agent and solvent. Such methods, wherein the epoxy resin is a liquid epoxy resin at room temperature. Such methods, wherein the epoxy resin is selected from bisphenol A epoxy resins, bisphenol F epoxy resins, or combinations thereof. Such methods, wherein the epoxy resin is selected from bisphenol A epoxy resins. Such methods, wherein the epoxy resin comprises bisphenol A diglycidyl ether (BADGE) epoxy resin. Such methods, wherein the diluent is a reactive diluent. Such methods, wherein the diluent functions as a compatabilizer for the epoxy resin and the phenalkamide curing agent. Such methods, wherein the diluent is a cashew nut shell liquid (CNSL) based diluent. Such methods, wherein the diluent comprises epoxy functional groups. Such methods, wherein the diluent has an epoxy equivalent weight (EEW) of about 350 g/1 mole to about 575 g/1 mole. Such methods, wherein the diluent has a dynamic viscosity of about 20 centipoise (cp) to 70 cp. Such methods, wherein the second composition further comprises a second curing agent. Such methods, wherein the second composition further comprises a phenalkamine curing agent. Such methods, wherein the coating composition comprises from about 50 wt % to about 65 wt % epoxy resin based on the total weight of the epoxy resin, diluent, curing agent and optional solvent. Such methods, wherein the coating composition comprises from about 55 wt % to about 60 wt % epoxy resin based on the total weight of the epoxy resin, diluent, curing agent and optional solvent. Such methods, wherein the coating composition comprises from about 57 wt % to about 59 wt % epoxy resin based on the total weight of the epoxy resin, diluent, curing agent and optional solvent. Such methods, wherein the coating composition comprises from about 5 wt % to about 25 wt % diluent based on the total weight of the epoxy resin, diluent, curing agent and optional solvent. Such methods, wherein the coating composition comprises from about 5 wt % to about 20 wt % diluent based on the total weight of the epoxy resin, diluent, curing agent and optional solvent. Such methods, wherein the coating composition comprises from about 10 wt % to about 15 wt % diluent based on the total weight of the epoxy resin, diluent, curing agent and optional solvent. Such methods, wherein the coating composition comprises from about 20 wt % to about 40 wt % curing agent based on the total weight of the epoxy resin, diluent, curing agent and optional solvent. Such methods, wherein the coating composition comprises from about 25 wt % to about 35 wt % curing agent based on the total weight of the epoxy resin, diluent, curing agent and optional solvent. Such methods, wherein the coating composition comprises from about 27 wt % to about 31 wt % curing agent based on the total weight of the epoxy resin, diluent, curing agent and optional solvent. Such methods, wherein the coating composition has a dynamic viscosity from about 1 to about 8 poise at 20° C. Such methods, wherein the coating composition has a dynamic viscosity from about 2 poise to about 6 poise at 20° C. Such methods, wherein the coating composition is applied to the inner surface of the pipe using airless spraying. Such methods, wherein one or both of the first and second compositions are heated before being mixed. Such methods, wherein one or both of the first and second compositions are heated while being mixed. Such methods, wherein one or both of the first and second compositions are heated before being mixed and while being mixed.

Some illustrative embodiments include coated pipes comprising: a pipe comprising an inner surface and an outer surface; and a coating in contact with at least a portion of the inner surface of the pipe, the coating comprising the reaction product of: a first composition comprising epoxy resin and a diluent; and a second composition comprising a curing agent, the curing agent comprising a phenalkamide curing agent.

In the following paragraph “such pipes” refer to the illustrative pipes immediately above as well as any other pipes disclosed in this paragraph or application generally. Such pipes, wherein the coating has a thickness from about 70 micrometers to about 90 micrometers. Such pipes, wherein the coating has a hardness of not less than 94 Buchholz at 25+1° C. when measured using ISO 2815. Such pipes, wherein the coating has a gloss rating of not less than 50 as measured by BS EN ISO 2813 at 60°. Such pipes, wherein the coating has a gloss rating of not less than 75 as measured by BS EN ISO 2813 at 60°. Such pipes, wherein the coating has a gloss rating of not less than 80 as measured by BS EN ISO 2813 at 60°. Such pipes, wherein the coating has a gloss rating of not less than 85 as measured by BS EN ISO 2813 at 60°. Such pipes, wherein the coating has a flexibility of not greater than 13 mm as measured by the Bend test of ISO 6860. Such pipes, wherein the coating has a flexibility of not greater than 10 mm as measured by the Bend test of ISO 6860. Such pipes, wherein the coating has a flexibility of not greater than 7 mm as measured by the Bend test of ISO 6860.

Objects and advantages of this disclosure may be further illustrated by the following non-limiting examples, but the particular materials and amounts thereof recited in these examples, as well as other conditions and details should not be construed to limit this disclosure in any way.

### EXAMPLES

Unless otherwise noted, all chemicals used in the examples can be obtained from Sigma-Aldrich Corp. (Saint Louis, Mo.).

General Testing Methods

The glossiness of the coated compositions was tested using BS EN ISO 2813: at 60°. The hardness of the coated compositions was tested using ISO 2815. The flexibility of the coated compositions was tested using ISO 6860. The solvent resistance (after curing at 24 hours at 20° C.) was tested using ASTM D5402-06 with methyl ether ketone as the solvent.

Natural Gas Transmission Flow Efficiency Coating Testing Methods

One of the coatings was subjected to full testing in accordance with the internationally recognized performance specifications for natural gas transmission flow efficiency coatings. This testing can be found in ISO 15741:2001 (Paints and Varnishes—Friction reduction coatings for the interior of on- and offshore steel pipelines for non-corrosive gases), Dec. 15, 2001; and the American Petroleum Institute Recommended Practice 5L2 (API RP 5L2), July 2002—Recommended Practice for Internal Coating of Line Pipe for Non-Corrosive Gas Transmission Service.

### Comparative Example 1

A two part composition was prepared. Part A of the two part composition included the following:

| | Weight |
|---|---|
| | percent |
| PART A | (wt %) |
| D.E.R. ™ 331 liquid epoxy resin (Dow Chemical | 48.47 |
| Company, Midland, MI) | |
| n-butyl acetate | 2.92 |
| TEGO ® Airex 922 deaerator (Evonik Industries, | 0.2 |
| Essen, Germany) | |
| CAB-O-SIL ® TS-720 treated fumed silica (Cabot Corp., | 1.08 |
| Billerica, MA) | |
| GARAMITE ® 1958 organoclay (BYK Additives, | 0.53 |
| Gonzales, TX) | |
| Xylene | 9.4 |
| MICRODOL H600 dolomite powder (Omya, Derby, | 22.24 |
| Great Britain) | |
| Synthetic red iron oxide pigment (Cathay Pigments (China) | 15.16 |
| Ltd., Kowloon, Hong Kong) | |

Part B of the two part composition included the following:

| | Weight |
|---|---|
| | percent |
| Part B | (wt %) |
| LITE 3040 epoxy curing agent (Cardolite Corporation, | 100 |
| Newark, NJ) | |

A composition was made by mixing Part A and Part B at 100:26 by weight. The composition was spray coated onto mild carbon steel panels and abrasive blast cleaned to surface preparation grade Sa2.5 in accordance with ISO 850-1 to give a surface profile of approximately 50 micrometers.

Table 1 below shows the results of the gloss, hardness, flexibility and solvent resistance testing.

TABLE 1

| Test | Method | Result |
|---|---|---|
| Gloss | BS EN ISO 2813 60° | 50 gloss units |
| Hardness (Buchholz) | ISO 2815 | 100 |
| Bend test | ISO 6860 | 13 mm diameter |
| Solvent Resistance | ASTM D5402-06 | 50 double rubs |

This composition resulted in a coating with low gloss that did not meet the applicable specification requirement, although other coating properties appeared favorable. When the composition was allowed an induction period of 15 to 30 minutes after mixing (as per the recommendation of the manufacturer of the curing agent), the gloss level of the cured coating increased to an acceptable level. However, an induction period is not possible when dual feed airless spray application equipment is being used, which is standard procedure in modern pipe coating plants. Therefore, a means of achieving immediate compatibility would need to be established to facilitate utility of such a composition as an internal pipe coating product.

### Example 1

The composition from Comparative Example 1 was retained except that a portion of the D.E.R.™ 331 liquid epoxy resin was replaced with an epoxy functional, cashew nut oil derived reactive diluent (Cardolite UL 513, Cardolite Corporation, Newark, N.J.). Addition of this reactive diluent decreased the time necessary for compatibility with the cashew nut oil derived curing agent. Table 2 below shows the amounts of the reactive diluent added to Part A.

TABLE 2

| | Ex. 1A | Ex. 1B | Ex. 1C | Ex. 1D | Ex. 1E | Ex. 1F |
|---|---|---|---|---|---|---|
| D.E.R. ™ 331 liquid epoxy resin | 100 | 95 | 90 | 85 | 80 | 75 |
| Cardolite UL 513 reactive diluent | 0 | 5 | 10 | 15 | 20 | 25 |
| Cardolite L3040 curing agent | 54 | 54 | 54 | 54 | 54 | 54 |
| Mixture clarity | Cloudy | Cloudy | Slightly | Clear | Clear | Clear |
| (visual assessment) | | | cloudy | | | |

### Example 2

A two part composition was prepared. Part A of the two part composition included the following:

| | Weight |
|---|---|
| | percent |
| PART A | (wt %) |
| D.E.R. ™ 331 liquid epoxy resin (Dow Chemical | 44.03 |
| Company, Midland, MI) | |
| Cardolite Ultra LITE 513 reactive diluent (Cardolite | 9.16 |
| Corporation, Newark, NJ) | |
| n-butyl acetate | 2.65 |
| TEGO ® Airex 922 deaerator (Evonik Industries, | 0.18 |
| Essen, Germany) | |
| CAB-O-SIL ® TS-720 treated fumed silica (Cabot | 0.98 |
| Corp., Billerica, MA) | |
| GARAMITE ® 1958 organoclay (BYK Additives, | 0.48 |
| Gonzales, TX) | |
| Xylene | 8.55 |
| MICRODOL H600 dolomite powder (Omya, Derby, | 20.2 |
| Great Britain) | |
| Synthetic red iron oxide pigment (Cathay Pigments (China) | 13.77 |
| Ltd., Kowloon, Hong Kong) | |

Part B of the two part composition included the following:

| | Weight percent |
|---|---|
| Part B | (wt %) |
| LITE 3040 epoxy curing agent (Cardolite Corporation, | 100 |
| Newark, NJ) | |

A composition was made by mixing Part A and Part B at 100:22 by weight. The composition was spray coated onto mild carbon steel panels abrasive blast cleaned to surface preparation grade Sa2.5 in accordance with ISO 850-1 to give a surface profile of approximately 50 micrometers.

The coating composition included 58.6 wt % liquid epoxy resin, 12.2 wt % reactive diluent, 29.2 wt % LITE 3040 curing agent and 14.9 wt % solvent (all wt % here given as the percentage based on the total liquid epoxy resin, reactive diluent, curing agent and solvent).

Table 3 below shows the results of the gloss, hardness, flexibility and solvent resistance testing.

TABLE 3

| Test | Method | Result |
|---|---|---|
| Gloss | BS EN ISO 2813 60° | 85 gloss units |
| Hardness (Buchholz) | ISO 2815 | 91 |
| Bend test | ISO 6860 | 4 mm diameter |
| Solvent Resistance | ASTM D5402-06 | 20 double rubs |

### Example 3

A two part composition was prepared. Part A of the two part composition included the following:

| | Weight |
|---|---|
| | percent |
| PART A | (wt %) |
| D.E.R. ™ 331 liquid epoxy resin (Dow Chemical Company, | 44.03 |
| Midland, MI) | |
| Cardolite Ultra LITE 513 reactive diluent (Cardolite | 9.16 |
| Corporation, Newark, NJ) | |
| n-butyl acetate | 2.65 |
| TEGO ® Airex 922 deaerator (Evonik Industries, Essen, | 0.18 |
| Germany) | |
| CAB-O-SIL ® TS-720 treated fumed silica (Cabot Corp., | 0.98 |
| Billerica, MA) | |
| GARAMITE ® 1958 organoclay (BYK Additives, Gonzales, | 0.48 |
| TX) | |
| Xylene | 8.55 |
| MICRODOL H600 dolomite powder (Omya, Derby, Great | 20.2 |
| Britain) | |
| Synthetic red iron oxide pigment (Cathay Pigments (China) Ltd., | 13.77 |
| Kowloon, Hong Kong) | |

Part B of the two part composition included the following:

| | Weight |
|---|---|
| | percent |
| Part B | (wt %) |
| LITE 3060 epoxy curing agent (Cardolite | 100 |
| Corporation, Newark, NJ) | |

A composition was made by mixing Part A and Part B at 100:22 by weight. The composition was spray coated onto mild carbon steel panels abrasive blast cleaned to surface preparation grade Sa2.5 in accordance with ISO 850-1 to give a surface profile of approximately 50 microns by spray.

The coating composition included 58.6 wt % liquid epoxy resin, 12.2 wt % reactive diluent, 29.2 wt % LITE 3060 curing agent and 14.9 wt % solvent (all wt % here given as the percentage based on the total liquid epoxy resin, reactive diluent, curing agent and solvent).

Table 4 below shows the results of the gloss, hardness, flexibility and solvent resistance testing.

TABLE 4

| Test | Method | Result |
|---|---|---|
| Gloss | BS EN ISO 2813 60° | 82 gloss units |
| Hardness (Buchholz) | ISO 2815 | 87 |
| Bend test | ISO 6860 | 3 mm diameter |
| Solvent Resistance | ASTM D5402-06 | 20 double rubs |

The coating compositions of Examples 2 and 3 exhibit enhanced gloss and flexibility but are detrimentally affected in terms of both hardness and solvent resistance, when compared to Comparative Example 1.

### Example 4

A two part composition was prepared. Part A of the two part composition included the following:

| | Weight |
|---|---|
| | percent |
| PART A | (wt %) |
| D.E.R. ™ 331 liquid epoxy resin (Dow Chemical | 44.03 |
| Company, Midland, MI) | |
| Cardolite Ultra LITE 513 reactive diluent (Cardolite | 9.16 |
| Corporation, Newark, NJ) | |
| n-butyl acetate | 2.65 |
| TEGO ® Airex 922 deaerator (Evonik Industries, | 0.18 |
| Essen, Germany) | |
| CAB-O-SIL ® TS-720 treated fumed silica (Cabot | 0.98 |
| Corp., Billerica, MA) | |
| GARAMITE ® 1958 organoclay (BYK Additives, | 0.48 |
| Gonzales, TX) | |
| Xylene | 8.55 |
| MICRODOL H600 dolomite powder (Omya, Derby, Great | 20.2 |
| Britain) | |
| Synthetic red iron oxide pigment (Cathay Pigments (China) | 13.77 |
| Ltd., Kowloon, Hong Kong) | |

Part B of the two part composition included the following:

| | Weight |
|---|---|
| | percent |
| Part B | (wt %) |
| LITE 3040 epoxy curing agent (Cardolite Corporation, | 76.11 |
| Newark, NJ) | |
| ANCAMINE ® 2719 curing agent (Air Products and | 19.03 |
| Chemicals, Inc., Allentown, PA) | |
| DOWANOL ™ PM propylene glycol methyl ether | 4.86 |
| (Dow Chemical Company, Midland, MI) | |

A composition was made by mixing Part A and Part B at 100:22 by weight. The composition was spray coated onto mild carbon steel panels abrasive blast cleaned to surface preparation grade Sa2.5 in accordance with ISO 850-1 to give a surface profile of approximately 50 micrometers by spray.

The coating composition included 58.4 wt % liquid epoxy resin, 12.2 wt % reactive diluent, 29.4 wt % LITE 3040 curing agent and 16.4 wt % solvent (all wt % here given as the percentage based on the total liquid epoxy resin, reactive diluent, curing agent and solvent).

Table 5 below shows the results of the gloss, hardness, flexibility and solvent resistance testing.

TABLE 5

| Test | Method | Result |
|---|---|---|
| Gloss | BS EN ISO 2813 60° | 85 gloss units |
| Hardness (Buchholz) | ISO 2815 | 94 |
| Bend test | ISO 6860 | 6 mm diameter |
| Solvent Resistance | ASTM D5402-06 | 40 double rubs |

Coated samples (4″×6″ and 2′×6″ by 1/16 of an inch thickness) of the composition of Example 4 were subjected to API RP 5L2 testing: salt spray (ASTM B117, 500 hours), water immersion (saturated CaCO2 solution in distilled water 100% immersion, room temperature, 21 days), methanol and water immersion (equal parts by volume methanol and water 100% immersion, room temperature, 5 days), stripping, bend (ASTM D522), adhesion, hardness (DIN 53 153), abrasion (ASTM D968), gas blistering and hydraulic blistering; and ISO 15741:2001: adhesion (ISO 2409), hardness (ISO 2815), salt spray (ISO 7253, 480 hours), artificial aging (conditions for 100 hours at 80° C. (176° F.)), bend (ISO 6860), water immersion (ISO 2812-2 for 480 hours); resistance to chemicals—diethylene glycol (DEG), tiethyleneglycol (TEG), 100% methanol, hexane, toluene, cyclohexane, lubricating oil, mono ethyleneglycol (MEG), and methyldiethanolamine (MDEA) (ISO 2812-1:1993), gas pressure variations (10 days), hydraulic blistering (24 hours) and decompression blistering (24 hours). The coated samples passed all of the tests in both the API RP 5L2 and the ISO 15741:2001.

Thus, embodiments of methods for coating inner surfaces of pipes and coated pipes formed thereby are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation.

1. A method of coating an inner surface of a pipe, the method comprising:
mixing a first composition with a second composition to form a coating composition the first composition comprising epoxy resin and diluent; and
the second composition comprising a curing agent, the curing agent comprising a phenalkamide curing agent; and
applying the coating composition to the inner surface of the pipe.

2. The method according to claim 1, wherein the first composition, the second composition, or both further comprise solvent.

3. The method according claim 1, wherein the coating composition comprises not greater than about 30 wt % solvent based on the total weight of the epoxy resin, diluent, curing agent and solvent.

4. (canceled)

5. The method according claim 1, wherein the coating composition comprises not greater than about 18 wt % solvent based on the total weight of the epoxy resin, diluent, curing agent and solvent.

6. The method according to claim 1, wherein the epoxy resin is a liquid epoxy resin at room temperature.

7. The method according to claim 1, wherein the epoxy resin is selected from bisphenol A epoxy resins, bisphenol F epoxy resins, or combinations thereof.

8. The method according to claim 1, wherein the epoxy resin is selected from bisphenol A epoxy resins.

9. (canceled)

10. The method according to claim 1, wherein the diluent comprises a reactive diluent.

11. The method according to claim 1, wherein the diluent functions as a compatabilizer for the epoxy resin and the phenalkamide curing agent.

12-13. (canceled)

14. The method according to claim 1, wherein the diluent has an epoxy equivalent weight (EEW) of about 350 g/1 mole to about 575 g/1 mole.

15-16. (canceled)

17. The method according to claim 1, wherein the second composition further comprises a phenalkamine curing agent.

18. The method according to claim 1, wherein the coating composition comprises from about 50 wt % to about 65 wt % epoxy resin based on the total weight of the epoxy resin, diluent, curing agent and optional solvent.

19-20. (canceled)

21. The method according to claim 1, wherein the coating composition comprises from about 5 wt % to about 25 wt % diluent based on the total weight of the epoxy resin, diluent, curing agent and optional solvent.

22-28. (canceled)

29. The method according to claim 1, wherein the coating composition is applied to the inner surface of the pipe using airless spraying.

30-32. (canceled)

33. A coated pipe comprising:
a pipe comprising an inner surface and an outer surface; and
a coating in contact with at least a portion of the inner surface of the pipe, the coating comprising the reaction product of:
a first composition comprising epoxy resin and a diluent; and
a second composition comprising a curing agent, the curing agent comprising a phenalkamide curing agent.

34. The pipe according to claim 33, wherein the coating has a thickness from about 70 micrometers to about 90 micrometers.

35. The pipe according to claim 33, wherein the coating has a hardness of not less than 94 Buchholz at 25±1° C. when measured using ISO 2815.

36-39. (canceled)

40. The pipe according claim 33, wherein the coating has a flexibility of not greater than 13 mm as measured by the Bend test of ISO 6860.

41-42. (canceled)
